(19) United States
(12) Patent Application Publication
(10) Pub. No.: US 2012/0097549 A1
(43) Pub. Date: Apr. 26, 2012

(54) ELECTROCHEMICAL CELL AND METHOD FOR SEPARATING CARRIER-FREE 18F-FROM A SOLUTION ON AN ELECTRODE

(75) Inventor: Kurt Hamacher, Aachen (DE)

(73) Assignee: Forschungszentrum Juelich GmbH, Juelich (DE)

(21) Appl. No.: 13/261,038

(22) PCT Filed: Apr. 17, 2010
(86) PCT No.: PCT/DE2010/000436

§ 371 Date: Nov. 22, 2011

(30) Foreign Application Priority Data
May 30, 2009 (DE) 10 2009 023 544.2

(51) Int. Cl. C25B 1/24; C25B 15/08; C25B 15/02; C25B 9/00; B01D 59/40

(52) U.S. Cl. 205/350; 204/275.1; 204/278.5; 205/619

(57) ABSTRACT

Disclosed is an electrochemical cell and a method for separating carrier-free radionuclides from a solution on an electrode. ¹⁸F⁻ is precipitated in an electrochemical cell from an aqueous solution on an anode, which is diamond-coated. Subsequently, the electrochemical cell is dried and supplied with a liquid containing a transfer catalyst, the anode is preferably switched to serve as the cathode, and ¹⁸F⁻ is transferred to the liquid phase.

The invention relates to an electrochemical cell and to a method for separating carrier-free ¹⁸F⁻ from a solution on an electrode.

A method and a device for separating carrier-free radionuclides from a solution are known from the document DE 195 00 428 A1. This document discloses a device and a method for separating carrier-free radionuclides from target liquids. In the device, a Sigradur® cylinder and a platinum capillary are connected to a direct current source. Carrier-free ¹⁸F⁻ is separated on the Sigradur® cylinder, which functions as an anode. The desorption of ¹⁸F⁻ is carried out by reversing the polarity of the electrodes. Sigradur® here denotes vitreous carbon.

In the methods according to the prior art, loss of carrier-free ¹⁸F fluoride occurs as compared to the quantity present in the solution, whereby the usable radioactivity quantity is decreased by up to 40%.

It is therefore the object of the invention to create a method and a device whereby loss of ¹⁸F⁻ is drastically minimized.

Starting from the preamble of claim 1, the object is achieved according to the invention by the features provided in the characterizing part of claim 1.

The device and the method according to the invention now make it possible to increase desorption of [¹⁸F] fluoride from the electrode to more than 90%, which is an improvement over the prior art according to DE 195 00 428 A1. The separation of ¹⁸F⁻ takes place on a robust, chemically inert surface. The crystal structure of the electrode surface prevents introduction of the valuable radioisotope and fast recovery in solution. The ¹⁸F⁻ is separated more quickly than with the methods according to the prior art. Any intercalation of valuable ¹⁸F⁻ in the anode material is suppressed, so that no ¹⁸F⁻ is withdrawn during the ¹⁸F⁻ recovery process.

Advantageous refinements of the invention will be apparent from the dependent claims and the description.

The invention will be described hereafter in general terms.

Device

The device according to the invention comprises an electrochemical cell, comprising two electrodes, the surfaces of which are diamond-coated at least in some regions.

The electrodes can preferably be switched off, or the polarity thereof can be reversed, so that one can selectively be switched to serve as the anode and the other as the cathode. When carrying out the method according to the invention, reversing the polarity of the electrodes, or switching the electrodes off, has the advantage that the separation of ¹⁸F⁻ from the electrode is favored, whereby the method is improved.

In a preferred embodiment, the electrodes are diamond-coated over the entire surface on the side that is in contact with a solution present in the electrochemical cell.

In general, all electrically conductive materials are possible options as diamond-coated electrode materials, and notably metals, with tungsten, molybdenum or titanium being particularly preferred. The diamond coating can be applied by means of CVD (chemical vapor deposition).

The diamond layer present on the electrode surface is preferably doped so as to render the layer electrically conductive. Because pure diamond is not electrically conductive, the fluoride is fixed to an undoped diamond surface by electrostatic field action alone.

In a preferred embodiment, the diamond layer is doped with boron. In a preferred embodiment, the electrodes, which is to say the anode and the cathode, have a plane-planar geometry.

In a further preferred embodiment, the surfaces of the anode and cathode are disposed parallel to each other.

The distance of the electrodes, or electrode surfaces, which is to say of the anode and the cathode, is preferably small and is 0.1 mm to 0.5 mm, for example. This has the advantage that the volume of the cell is as small as possible, and the optimal range of the electric field strength (for example ≦200 V/cm, such as 100 V/cm) can be reached even with low voltages of ≦20 V, for example.

This has the advantage that, at a given voltage, ¹⁸F⁻ can be separated fully and quickly on the anode, even with minimal quantities of ¹⁸F⁻ present in a liquid between the electrodes.

The electrodes are preferably equipped with temperature control means. Possible temperature control means include, for example, liquid flows, or preferably Peltier elements. The temperature control means can be used to reach temperatures as required depending on the experiment. For example, temperatures in a range between −10° C. and 150° C. can be set.

Moreover, the electrochemical cell is equipped with means for supplying and removing liquids. To this end, one embodiment may be such that only one feed line is present, which during a batch operation also serves as a discharge line. In this case, means for pressure equalization are preferably present so as to enable good filling. It is also possible for separate feed and discharge lines to be present, which allow through-flow. In the case of separate feed and discharge lines, these are preferably located on opposing sides of the electrochemical cell, or on the surface of the planar electrodes. Moreover, the cell can be connected to a feeding or discharging hose connection at the two opposing ends, or on the surfaces of the electrodes, by means of a plug-in, or alternatively screw-on, flange connection. The feeding and discharging of the cell allows the cell to be operated by filling the cell with the appropriate radioactive solution in batch mode by means of one-time filling, or to be operated as a flow cell having a steady volume flow.

In a further preferred embodiment, the diamond-coated surface of the electrode is chemically functionalized, for example by hydroxylating, aminating or sulfhydrating the outer carbon atoms, so that the surface has more hydrophilic properties and thus improved wettability. Moreover, the functional groups can be utilized to reversibly bind reactants.

In a particularly preferred embodiment, the electrodes, which are the diamond-coated anode and the diamond-coated cathode, are designed as plane-parallel plates, which define a space for receiving a liquid and which are joined in the edge regions thereof and attached to each other by way of mutually sealing edge zones.

The attachment can be done by way of screw assemblies using bores in the edge regions, or using clamping connections.

The edge regions are preferably connected to each other in a fluid-tight manner. To this end, a polymer gasket or a plastic sealing compound can be employed, for example. Still more preferably, the edge regions are connected to each other in a fluid-tight and electrically non-conductive manner. In this embodiment, the contact points of the anode and cathode are preferably electrically insulated from each other. This can be done by a pure diamond layer that is not doped, or by means of other electric insulators, such as plastic. If the seal should not be sufficient to prevent liquid from leaking through the diamond layer, a polymer film or a plastic sealing material can additionally be used to seal the cell. The film is preferably electrically insulating and has high electric resistance. Polyolefins, such as polypropylene, are suitable materials for a film.

The drawings show a schematic illustration of a particularly preferred embodiment of the electrochemical cell according to the invention.

In the drawings:

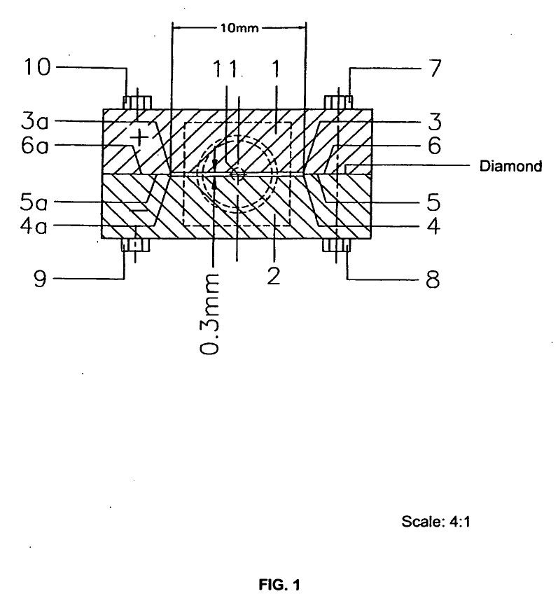

FIG. 1: shows a cross-section of the electrochemical cell according to the invention.

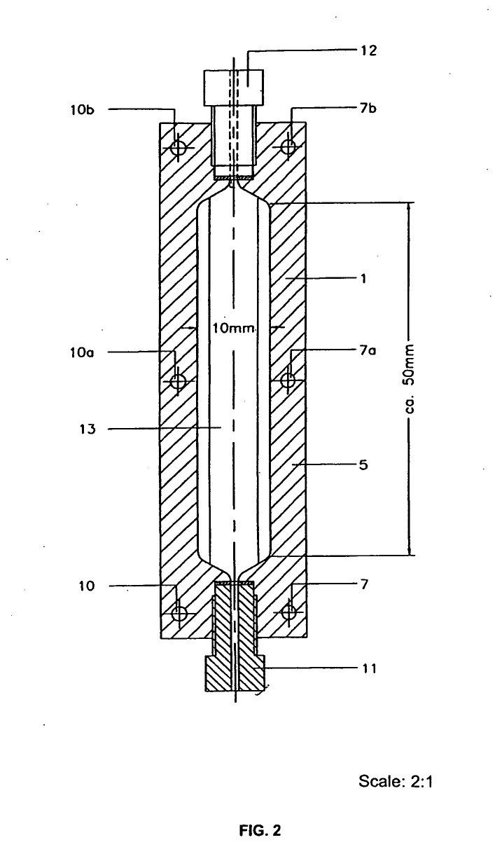

FIG. 2: shows an electrochemical cell according to the invention.

FIG. 1 shows a cross-section of an electrochemical cell according to the invention. In it, the anode 1 and the cathode 2 define an internal volume, which can receive a liquid. In the edge regions, the anode 1 and the cathode 2 have respective steps 3, 3a, 4, 4a, which surround them and are parallel to each other in the outer regions, so that they form plane-parallel plates 5, 5a, 6, 6a, which can be screwed together through bores 7, 8, 9, 10. The surfaces of the anode 1 and cathode 2 are diamond-coated. A diamond layer is present on at least one plane-parallel plate 5, 5a or 6, 6a. The steps 3, 3a, 4, 4a are likewise diamond-coated. The cross-section 11 of a feed line is shown at the center of the figure.

FIG. 2 shows a top view of an electrochemical cell according to the invention. Identical features of the device are denoted by the same reference numerals as in FIG. 1. A discharge line 12 is located opposite of the feed line 11. Additional bores for screw assemblies are denoted by reference numerals 7a, b and 10a, b. On the anode 1, a region 13 is shown in which the diamond-coated surface of the cathodes can be doped with boron.

Method

According to the claimed method of the invention, an aqueous solution of ¹⁸F⁻ is conducted into the electrochemical cell according to the invention comprising a diamond-coated anode 1 and a diamond-coated cathode 2. A voltage is applied to the electrodes. The ¹⁸F⁻ is thereby fixed to the diamond-coated anode 1, which may be doped. The diamond surface is preferably doped with boron.

In a further step, the electrochemical cell is drained and dried. For drying, the electrochemical cell is rinsed with an anhydrous, preferably organic, solvent. The solvent is preferably conducted through the cell. It is also preferred that the solvent rinsing be carried out while a voltage is applied.

In a simple embodiment of the method, an organic solvent containing a transfer catalyst is introduced in a further step so as to separate or desorb the ¹⁸F⁻ from the diamond surface of the anode 1.

In a preferred embodiment, the solvent is aprotic, and still more preferably a dipolar aprotic solvent.

Acetonitrile, DMSO and dimethylformamide can be used as solvents, for example.

However, other solvents, such as mixtures of acetronitrile and tertiary alcohols, can also be used, provided that the pKₐ values thereof identify them as extremely weak acids. Tert-butanol can be mentioned by way of example as an alcohol.

In a preferred embodiment, a cryptand is employed as the transfer catalyst, such as Kryptofix 2.2.2.® (=4,7,13,16,21,24-hexaoxa-1,10-diazabicyclo[8.8.8]hexacosane), or tetrabutylammonium salts, such as tetrabutylammonium hydrogen carbonate.

During this desorption process, the polarity of the electrodes is preferably reversed, or the electrodes are depolarized by merely switching off the voltage source. Particularly in the case of polarity reversal, this effects better separation of the ¹⁸F⁻ from the electrode.

The transfer catalyst solution loaded with ¹⁸F⁻ is preferably removed from the electrochemical cell and the ¹⁸F⁻ thus recovered is supplied to the further chemical reaction. Depending on the desired product, an agent is supplied that converts to the target compound in a nucleophilic reaction. The reactions are known from the prior art.

The advantage of the electrochemical cell according to the invention and of the method according to the invention comes into play in the separation of the ¹⁸F⁻. Coating the electrodes with diamond material substantially prevents, or at least drastically suppresses, intercalation of valuable ¹⁸F⁻ in the electrode material, whereby no significant loss of ¹⁸F⁻ is incurred. Given the peripheral electrostatic bond of the [¹⁸F]fluoride with the diamond surface, the detachment kinetics of the anionic radioisotope during field polarity reversal is considerably faster and takes place with great efficiency, so that a higher percentage of activity is available for the further reaction. The separation of ¹⁸F⁻ thus also takes place more quickly and no loss of time occurs, which would result in a reduced radiochemical yield for the products, in view of the half-life value of ¹⁸F⁻.

In a preferred embodiment, the separation of ¹⁸F⁻ from the anode 1, which is now switched to serve as the cathode, is accelerated by raising the temperature. Preferred temperatures range between 50° C. and 100° C.

The field strengths employed are 1-100 V/cm, for example, depending on the electrode distance.

In a special embodiment of the method according to the invention, ¹⁸F⁻ can be bound to the anode and, during desorption into the phase transfer catalyst-containing organic solution, can be apportioned into the solution by controlling the duration of the polarity reversal, so that a recovery process can yield defined radioactivity quantities of ¹⁸F⁻ for various further processing steps.

### Example

An electrochemical flow cell comprising a planar, diamond-coated plate system for online fixation of [¹⁸F]fluoride, for the radiochemical reaction thereof inside the cell, or consecutive, portioned desorption.

The invention relates to a planar flow cell, by which a low-carrier [¹⁸F]fluoride can be anodically separated from an aqueous solution by applying an electric field and transferred, for example, to an organic solution by reversing the polarity of the field. The cell is composed of two planar electrodes, the one side of each of which is designed so as to create a flat hollow space, surrounded by a planar edge zone, when placing the two plates on top of each other. Two threaded feed and discharge openings are located at the ends of the cell. The feed and discharge zones of the flow cell are designed so that the inflowing or outflowing solution flows evenly through the cell. The length and width of the hollow space, as well as the distance between the plates, are adapted to the practical requirements of electrochemical fixation and desorption of the radionuclide. The inside surfaces of the electrodes are diamond-coated. The electrical conductivity can be adjusted by deliberately doping the diamond surface. The cell is sealed by connecting the planar, diamond-coated edge zones of the plates to each other by means of multiple screw assemblies or a clamping connection. The undoped diamond coating of the planar edge zone ensures electrical insulation between the two plates serving as electrodes. The planar flow cell is heated and cooled, for example, by Peltier elements attached to both sides of the cell.

Process Steps

1. Online Fixation of the [¹⁸F]Fluoride from the Target Water

[¹⁸F]fluoride-containing target water is conducted with a constant volume flow at a specific field strength through the flow cell so that the radioisotope is substantially completely precipitated on the planar electrode acting as the anode.

2. Drying the Cell

The cell is dried while an electric field is applied by passing an anhydrous organic solvent therethrough.

3. Quantitative or Portioned Desorption of the Anodically Precipitated [¹⁸F]Fluoride

The cell is filled with an organic solution, comprising a dipolar aprotic solvent and a transfer catalyst, and the anodically fixed [¹⁸F]fluoride is transferred into the organic solution by reversing the polarity of the electric field. The radioactivity fixed to the diamond-coated electrode surface can thus be transferred in portions into the organic solution, for example, by conducting the organic phase out of the cell after a defined residence time. Moreover, the activity separation from the electrode can be influenced by raising the temperature.

The detachment of [¹⁸F]fluoride from the electrode surface can be controlled by way of the duration of the polarity reversal so that only a fraction of the overall anodically fixed activity goes into solution and is thus made available to the consecutive chemical reaction process. By repeating this time-controlled desorption process, the overall amount of anodically precipitated radioactivity can be transferred in portions from the electrode surface into various fractions of phase transfer catalyst-containing organic solutions. The total activity can thus be apportioned after anodic precipitation and supplied to various subsequent reactions.

1. An electrochemical cell, comprising means for supplying and discharging liquids and two electrodes, the surfaces of the two electrodes being at least partially diamond-coated so that diamond surfaces are formed.

2. The electrochemical cell according to claim 1, wherein, the electrodes are diamond-coated over the entire surfaces thereof.

3. The electrochemical cell according to claim 1, wherein the diamond surface is doped.

4. The electrochemical cell according to claim 3, wherein, the diamond layer is doped with boron.

5. An electrochemical cell according to claim 1, wherein the electrodes are disposed plane-parallel to each other.

6. An electrochemical cell according to claim 1, wherein the distance between the electrodes is 0.1 mm to 0.5 mm.

7. An electrochemical cell according to claim 1, wherein the polarity of the electrodes can be reversed or the electrodes can be switched off.

8. An electrochemical cell according to claim 1, comprising temperature control means for controlling the temperature of the electrodes.

9. An electrochemical cell according to claim 1, wherein carbon atoms of the surface of the diamond layer are functionalized, and more particularly are hydroxylated, aminated or sulfhydrated.

10. An electrochemical cell according to claim 1, wherein in edge regions, the electrodes, which is to say the anode and the cathode, have respective steps which surround them and are parallel to each other in outer regions, so that they form plane-parallel plates, which can be connected to each other in a fluid-tight manner by fastening means.

11. An electrochemical cell according to claim 10, wherein the anode and the cathode are electrically insulated from each other.

12. A method for separating carrier-free ¹⁸F⁻ from a solution in an electrochemical cell on an electrode, comprising the following steps:
a) introducing an aqueous solution containing ¹⁸F⁻;
b) precipitating the ¹⁸F⁻ on the electrode which is switched to serve as the anode;
c) removing the solution from the electrochemical cell;
d) drying the electrochemical cell;
e) filling the electrochemical cell with a solution that contains a transfer catalyst; and
f) removing the resulting solution, which contains ¹⁸F⁻, wherein electrodes that are at least partially diamond-coated are employed.

13. The method according to claim 12, wherein, the drying process according to step d) is carried out using an anhydrous solvent.

14. The method according to claim 12, wherein the transfer catalyst according to step e) is supplied in an aprotic or dipolar aprotic solvent.

15. A method according to claim 12, comprising reversing the polarity of the electrodes, or depolarizing the electrodes by shutting the electrodes off, between steps e) and f).

16. A method according to claim 12, wherein a cryptand or tetrabutylammonium salt is employed in step e) as the transfer catalyst.

17. A method according to claim 12, wherein the electrochemical cell is operated at field strengths of 1 to 100 V/cm.

18. A method according to claim 17 being performed at an electrode distance of 0.1 mm to 0.5 mm.

19. A method according to claim 15, wherein the polarity reversal, or shutting off, of the electrodes is carried out at time intervals, so that the adsorbed ¹⁸F⁻ is delivered in portions of defined quantities.

20. A method according to claim 12, wherein an electrochemical cell is employed.
